(19) United States
(12) Patent Application Publication
(10) Pub. No.: US 2011/0311179 A1
(43) Pub. Date: Dec. 22, 2011

(54) COMPARTMENTALIZED FIBER OPTIC DISTRIBUTED SENSOR

(75) Inventor: Robert Greenaway, Frimley (GB)

(73) Assignee: SCHLUMBERGER TECHNOLOGY CORPORATION, SUGAR LAND, TX (US)

(21) Appl. No.: 12/818,998

(22) Filed: Jun. 18, 2010

(51) Int. Cl. G02B 6/00; G01L 9/00

(52) U.S. Cl. 385/12; 73/705

(57) ABSTRACT

A distributed fiber optic sensor comprises a conduit having a plurality of sealed compartment extending along its length. A sensing optical fiber is disposed in the conduit and extends through the sealed compartment to form a series of separate sensing elements, each of which separately respond to a parameter of interest that is incident along the length of the conduit. The compartmentalized conduit is surrounding by a protective layer that includes ports therethrough to allow transmission of the parameter through the protective layer to the separate sensing elements.

### BACKGROUND

Many forms of measurements performed with a fiber optic sensor can be taken as a distributed measurement of a parameter that is incident along the length of the optical fiber. For instance, in the hydrocarbon production industry, various downhole parameters, such as temperature, pressure, and fluid flow, may be monitored before or during production and/or before, during or after a well treatment using a distributed fiber optic sensor. Data gathered in this manner can provide useful information about characteristics of the hydrocarbon production. In addition, distributed fiber optic sensors may also be deployed in a wellbore during a seismic survey to provide information relating to the characteristics of an earth formation. In such applications, the fiber optic sensor typically is deployed in an environment in which the sensor is exposed to corrosive materials, as well as elevated temperatures and pressures. Thus, the fiber optic sensor is generally configured as a cable in which one or more sensing fibers are encased in a jacket or coating that protects the fiber from the environment. The jacket or coating is made of materials that allow certain measurement parameters (e.g., temperature, vibration, etc.) to naturally transfer through the jacket/coating to the sensing fiber or fibers. However, partially due to the protective characteristics of the outer jacket, not all parameters naturally transfer through the cable, thus limiting the spectrum of fiber optic distributed monitoring that may be performed.

### BRIEF DESCRIPTION OF THE DRAWINGS

Certain embodiments of the invention will hereafter be described with reference to the accompanying drawings, wherein like reference numerals denote like elements. It should be understood, however, that the accompanying drawings illustrate only the various implementations described herein and are not meant to limit the scope of various technologies described herein. The drawings are as follows:

FIG. 1 shows a transverse cross section of an exemplary fiber optic sensor cable in accordance with an embodiment of the invention.

FIG. 2 shows a cross section taken along the longitudinal axis of the sensor cable of FIG. 1.

FIG. 3 shows a transverse cross section of another exemplary fiber optic sensor cable in accordance with an embodiment of the invention.

FIG. 4 shows a cross section taken along the longitudinal axis of the sensor cable of FIG. 3.

FIG. 5 illustrates an exemplary deployment in a wellbore of the fiber optic sensor of FIGS. 1 and 2.

FIG. 6 illustrates an exemplary data acquisition subsystem that may be used with a fiber optic sensor in accordance with an embodiment of the invention.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via another element”; and the term “set” is used to mean “one element” or “more than one element”. As used herein, the terms “up” and “down”, “upper” and “lower”, “upwardly” and downwardly“, “upstream” and “downstream”; “above” and “below”; and other like terms indicating relative positions above or below a given point or element are used in this description to more clearly describe some embodiments of the invention.

Individual sensors and sensor arrays have long been deployed in wellbores for use in both temporary and long-term or permanent monitoring installations. In recent years, conventional fixed sensors and sensor arrays have been commonly replaced by distributed fiber optic sensors that are configured to respond along the length of the fiber to a parameter of interest. In such installations, the distributed measurements typically are limited to parameters that can naturally transfer through the cable to the sensing fiber or fibers, such as temperature and vibration. As a result, measurements of various parameters that could otherwise provide useful information related to hydrocarbon production, such as pressure and gas composition/concentration, but which do not readily transfer through the cable's protective coating or jacket in a manner in which they can generate a response in the optical fiber, have not been readily attainable.

Accordingly, embodiments of the invention provide for a fiber optic sensor cable that is configured to enhance the exposure and increase the sensitivity of the sensing fiber or fibers to conditions in the sensing environment (e.g., in a wellbore) so as to provide for measurements of a wide range of parameters, including temperature, vibration and pressure. Although providing greater exposure to the parameters of interest, the fiber optic sensor cable also is configured to provide sufficient protection to the sensing fiber or fibers from the sensing environment so that the fiber optic sensor cable may be deployed in a permanent installation, if desired.

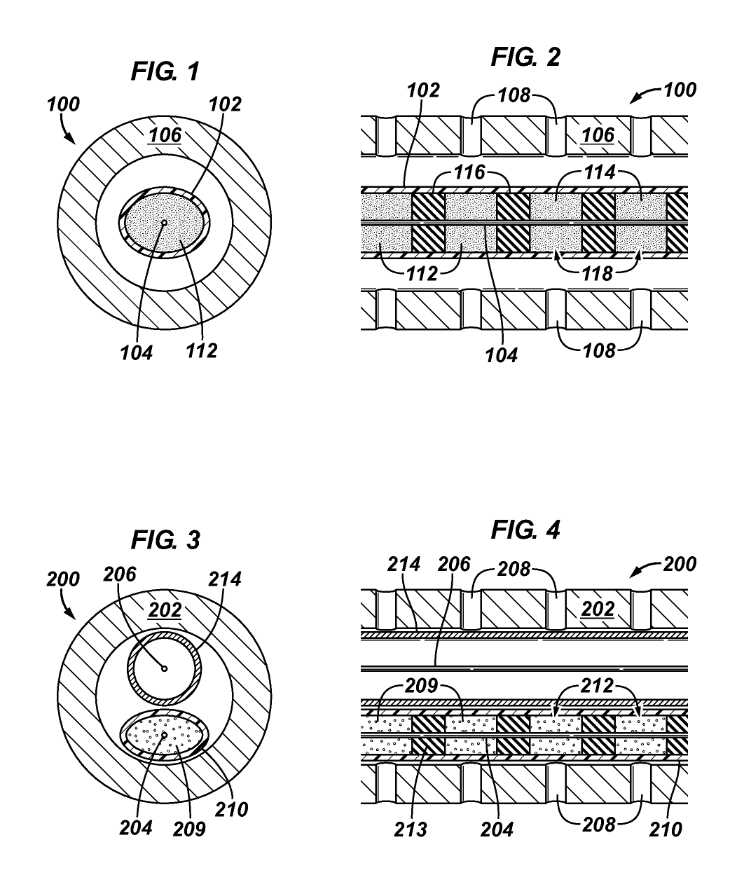

Towards that end, an illustrative embodiment of such a fiber optic sensor cable 100 is shown in FIGS. 1 and 2. FIG. 1 is a transverse cross-section of the sensor cable 100, and FIG. 2 is a cross-sectional view taken along the longitudinal axis of the cable 100. The sensor cable 100 includes an inner tube or conduit 102 through which one or more sensing optical fibers 104 extend. In this embodiment, the inner tube 102 is segregated from an outer protective layer 106 so that the inner tube 102 can respond (e.g., flex) independently of the outer layer 106 to a parameter of interest (e.g., pressure) that is incident on cable 100.

The outer protective layer 106 may be a coating or a jacket that protects the inner tube 102 and sensing fiber 104 from the environment in which the cable 100 is deployed. At the same time, the protective layer 106 is configured such that a parameter of interest can transfer through the layer 106 to the inner tube 102. For instance, in some embodiments, the protective layer 106 may be a metal armor having multiple ports or openings 108 therethrough to allow transfer of the sensed parameter to the inner tube 102. In the embodiment shown in FIG. 2, the ports 108 in the outer protective layer 106 are spaced at regular intervals along the length of the cable 100. In other embodiments, the spacing between ports 108 may be irregular or may be present only along selected sections of the cable 100.

In the embodiment shown in FIGS. 1 and 2, the sensor cable 100 is particularly well-suited to detect and provide indications of pressure incident on the cable 100. More particularly, to improve the sensitivity to pressure, the inner tube 102 is defined by a thin wall made of a flexible material, such as stainless steel, and is filled with a transmission medium 112 that enhances transfer of incident pressure to the sensing fiber 104. As examples, the transmission medium 112 may be a gel or liquid metal. In the embodiment of FIGS. 1 and 2, the inner tube 102 has an elliptical cross-section to provide further flexibility and, thus, to further enhance the sensitivity of the sensing fiber 104 to incident pressure. For instance, in an application in which the cable 100 is deployed in a hydrocarbon production environment, such as in or along a production tubing in a wellbore, pressure from a production fluid is transferred through the ports 108 of the outer armor 106 and is incident on the flexible inner tube 102, causing the tube 102 to flex. The fluid-filled inner tube 102 thus acts as a bellows that transfers the incident pressure through the transmission medium 112 to the sensing fiber 104. The sensing optical fiber 104 responds to the change in pressure incident along its length so that, when interrogated by an appropriate data acquisition system, a distributed measurement of the pressure along the length of the sensor cable 100 in the monitored environment can be provided.

In the illustrative embodiment of FIGS. 1 and 2, the inner tube 102 includes a series of pressure-sensitive sections or compartments 114 separated by seals 116 to create isolated sensing elements 118. Due to the compartmentalization, each sensing element 118 separately responds to the pressure that is incident on that particular element 118. As a result, a distributed measurement of pressure in the monitored environment can be obtained at a plurality of discrete locations along the length of the sensor cable 100. In embodiments which do not include compartmentalized sensing elements 118, the resulting measurement generally is an average of the pressure that is incident along the entire length of the sensor cable 100.

In other embodiments of the fiber optic sensor cable 100, such as in embodiments in which a parameter other than pressure is of interest, the inner tube 102 is compartmentalized into discrete sensing elements 118 but is configured to be resistant to pressure. For instance, the inner tube 102 may have a circular cross section that is substantially inflexible when exposed to pressure. In addition, each compartment 114 may be filled with a transmission medium 112 other than a pressure-transmitting liquid, e.g., air. For instance, in applications in which gas composition or gas concentration detection is of interest, the sensing fiber 104 may be configured to respond to various chemicals that are present in the monitored environment. In such applications, the outer armor 106 may include the ports 108, which allow the gas to readily impinge on the inner tube 102/sensing fiber 104 and/or may be made of a material that is nonresistant to the chemicals of interest.

Regardless of the application, the sensor cable 100 is constructed such that the sensing fiber 104 extends within the inner tube 102, which is segregated from the outer protective layer 106. The outer protective layer 106 provides protection from the environment so that the cable 100 may be included in a permanent monitoring installation, if desired. At the same time, the outer protective layer 106 is configured to allow transfer of the parameter of interest to the sensing fiber 104. To provide for point measurements of the parameter at each of a plurality of locations along the length of the sensing fiber 104, the inner tube 102 includes the series of compartments 114 that are separated from each other by the seals 116, thus creating the individual sensing elements 118 that extend along the length of the sensor cable 100. Any suitable material may be used for the outer protective layer 106, the inner tube 102, the seals 116, and the parameter transmission medium 112, and the particular materials may vary depending on the particular application and the characteristics of the environment in which the fiber optic sensor cable 100 is employed.

The length of each of the separately sealed sensing elements 118 also may vary depending on the application. For instance, the length of each sensing element 118 may be in the range of a few centimeters to several tens of meters. Likewise, the spacing between elements 118 may range between a few centimeters to tens of meters. The sensing elements 118 may be evenly spaced and their lengths may be uniform, or the spacing and lengths may vary along the length of the sensor cable 100 as may be suitable for the particular measurement and/or type of measurement being made.

In yet other embodiments, additional optical fibers and/or electronic conductors may also be incorporated in the sensor cable 100. One such embodiment is shown in the transverse and longitudinal cross-sectional views in FIGS. 3 and 4, respectively, of a sensor cable 200. In this embodiment, the sensor cable 200 includes an outer protective armor 202 in which sensing fibers 204 and 206 are disposed. The outer protective armor 202 includes ports 208 therethrough to allow the parameters of interest to transfer to the sensing fibers 204 and 206 while still providing protection from the monitored environment. Sensing fiber 204 is immersed in a pressure-sensitive fluid 209 contained within a pressure-sensitive flexible tubing 210 that is compartmentalized into separate sensing elements 212 by seals 213. Sensing fiber 206 is contained within a pressure-resistant conduit 214 and is configured to respond. along its length to a parameter other than pressure, such as temperature or vibration. In other embodiments, additional optical fibers may be included within either or both flexible tubing 210 and pressure-resistant conduit 214. For instance, an additional optical fiber that can be used for validation purposes may be desired in some applications.

Conventional manufacturing methods can be used to construct the sensor cables 100 and 200. As an example, the compartmentalized sensing elements 118/212 can be constructed by blowing, pumping, laying or otherwise disposing a sensing optical fiber 104/204 into the conduit or tube 102/210. Sealing elements 116/213 and transmitting media 112/209 suitable for enhancing transfer of the parameter of interest then may be installed. For instance, to fabricate a pressure-sensitive sensor cable, a pressure-transmitting fluid 112/209, such as a liquid metal, may be pumped into the elliptical, flexible tube 102/210 through which the sensing fiber 104/204 extends. The pressure-transmitting fluid 112/209 may be alternated with a slow set sealing fluid that is pumped into the tube 102/210 at regular intervals (e.g., every 10 meters) so that, when set, a series of the separate sensing elements 118/212 are formed. In an alternative embodiment, the tube 102/210 may be filled with the parameter-transmitting fluid 112/209 and then a sealing fluid may be injected through the wall of the tube 102/210 at selected locations (e.g., regular intervals of 10 meters) and allowed to set to form seals 116/213. It should be understood that the foregoing examples are illustrative only and that the compartmentalized sensing elements 118/212 may be formed in other manners using other manufacturing techniques and materials that are suitable for the particular application in which the sensor cable will be employed.

Regardless of the manner in which the compartmentalized sensing elements 118/212 are formed, the tube 102/210 containing the elements 118/212 is contained within the outer protective armor 106/202: As an example, a flat sheet of protective material, such as a metal protective armor, may be pre-drilled with spaced-apart openings to form the ports 108/208. The openings may be drilled in a regular pattern so that one or more of the openings will align with a sensor element 118/212. The compartmentalized tube 102/210 may be laid on the drilled armor sheet, and the armor sheet then rolled about the tube 102/210 and the edges welded together to form the protective outer layer 106/202. In embodiments which include additional sensing fibers and/or electrical conductors, these additional components may be spiraled together with the compartmentalized tube 102/210 before placing them into the protective armor 106/202. In general, the finished sensor cable 100/200 may have an outer diameter on the order of ¼ inch.

Again, the example provided above for encasing the compartmentalized tube 102/210 in a protective outer layer is illustrative only and other techniques may be used. For instance, for hydrocarbon production applications, the outer protective layer 106/202 may be provided by a perforated control line or wireline into which the compartmentalized inner conduit 102/210 may be pumped or otherwise deployed.

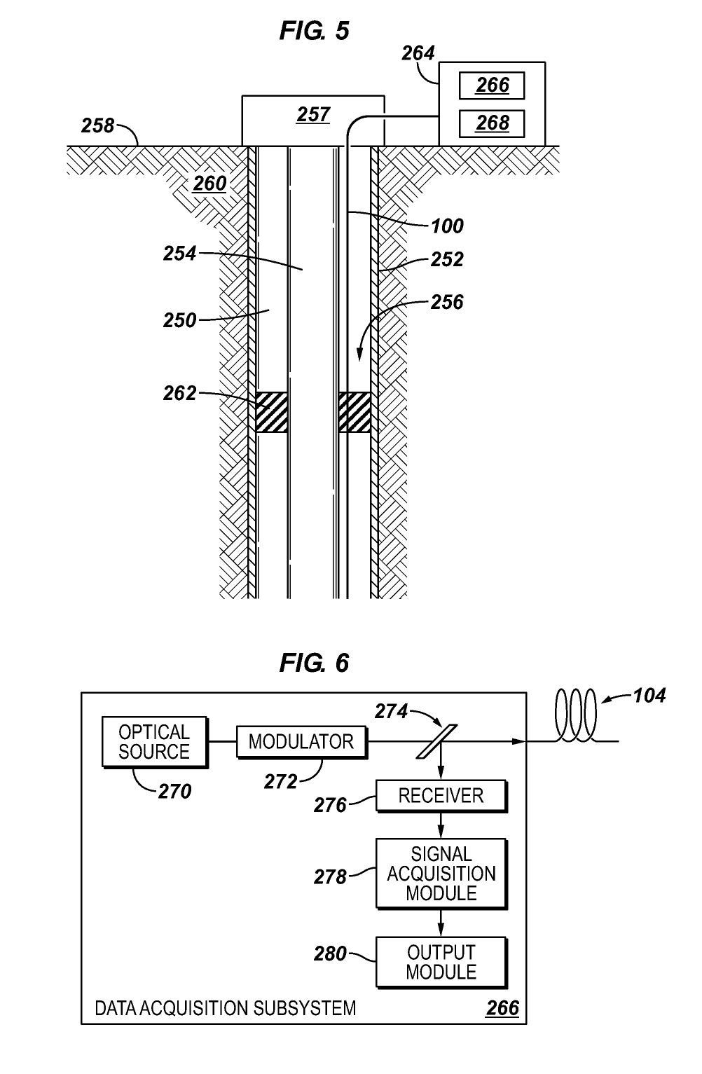

FIG. 5 shows an exemplary sensing cable 100 with compartmentalized sensing elements 118 deployed in the annulus 250 between a casing 252 and a production tubing 254 in a wellbore 256 that extends from a wellhead 257 at surface 258 into a formation 260. Monitoring may be performed along the completion string below and/or above a packer 262. When monitoring is performed below the packer 262, conventional inline downhole barriers provide the isolation needed prior to entry of the cable 100 through the packer 262. If used in the upper completion above the packer 262, conventional inline downhole barriers provide the isolation needed prior the entry of the cable 100 through a tubing hanger.

As shown in FIG. 5, the sensing cable 100 is coupled to a control system 264 at the surface which includes a data acquisition subsystem 266 and a processing subsystem 268 configured to interrogate the sensing optical fiber 104 and output and derive information regarding characteristics of the monitored parameter. For instance, as shown in FIG. 6, the data acquisition subsystem 266 can include an optical source 270 to generate an optical signal (e.g., an optical pulse or series of pulses) to launch into the sensing optical fiber 104. In some embodiments, the optical source 270 may be a narrowband laser that is followed by a modulator 272 that selects short pulses from the output of the laser. The optical signal or pulses generated by the optical source 270 are launched into the optical fiber 104 though a directional coupler 274, which separates outgoing and returning optical signals and directs the returning (backscattered) signals to an optical receiver 276. The directional coupler 274 may be a beam splitter, a fiber-optic coupler, a circulator, or some other optical device.

The backscattered optical signals generated by the optical fiber 104 in response to the interrogating optical signal may be detected and converted to an electrical signal at the receiver 276. This electrical signal may be acquired by a signal acquisition module 278 (e.g., an analog-to-digital converter) and then transferred as data representing the backscattered signals to an output module 280 for outputting the data to the processing subsystem 268. The processing subsystem 268 may process the data to determine characteristics of the parameter of interest (e.g., amount of pressure present at various locations in the monitored environment).

More particularly, the backscattered light is affected by the pressure that is incident on the optical fiber 104 due to simple elongation of the fiber that occurs when subjected to a strain (such as from pressure that is incident on the fiber). This elongation changes the relative position between the scattering centers of the optical fiber and also changes the refractive index of the glass. Both these effects alter the relative phase of the light scattered from each scattering center. As a result, characteristics of a parameter of interest that is incident on and strains the sensing fiber 104 may be determined by acquiring and processing data from the backscattered signal that is generated in response to an interrogating optical signal.

In embodiments in which the sensor cable 100 also includes electrical conductors, the control system 264 may also be arranged to transmit and receive control and status signals to and from various downhole components deployed in the wellbore 256. Data acquired from the sensor cable 100 by the control system 264 may be transmitted to a remote data center, if desired, for further processing, analysis, and/or storage.

The processing subsystem 268 of FIG. 5 can include a processor (or multiple processors) to perform processing and/or analysis of the parameter data and/or data representing the backscattered light from the optical fiber 104. Machine-readable instructions are executable on the processor(s) to perform the processing and analysis. A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

The sensor cable 100 may be deployed in the wellbore 256 in any of a variety of conventional manners. For instance, the cable 100 may be laid against either the inside or the outside of the completion tubing and deployed in the wellbore along with the completion components. Alternatively, the cable 100 may be deployed in the production tubing after completion is finished. Yet further, the installation of the cable 100 may be permanent or temporary and may be used, for instance, to monitor parameters during production or before, during and/or after a well treatment.

Although the foregoing embodiments have been described with respect to monitoring parameters in a hydrocarbon production well, it should be understood that embodiments of the sensor cable may also be used in any application in which measurement of a particular parameter at a plurality of separate locations distributed along a sensing fiber is desired. Moreover, while the foregoing embodiments have been described in the context of pressure monitoring and gas composition detection, it should be understood that embodiments of the sensor cable may be configured to monitor other types of parameters.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A distributed fiber optic sensor, comprising:
a conduit having a plurality of sealed compartments extending along the length of the conduit; and
a sensing optical fiber disposed in the conduit and extending through the sealed compartments to form a series of compartmentalized sensing elements that separately respond to a parameter incident along the conduit.

2. The sensor as recited in claim 1, further comprising a protective layer, wherein the conduit is surrounded by the protective layer, and wherein the protective layer is configured to allow transfer of the parameter through the protective layer to the conduit.

3. The sensor as recited in claim 2, wherein the protective layer comprises a plurality of ports therethrough to allow transfer of the parameter to the conduit.

4. The sensor as recited in claim 2, further comprising a transmission medium to enhance response of the sensing optical fiber to the parameter.

5. The sensor as recited in claim 4, wherein the conduit comprises a plurality of seals to seal the transmission medium in each of the sealed compartments.

6. The sensor as recited in claim 4, wherein the conduit has an elliptical transverse cross section.

7. The sensor as recited in claim 2, further comprising:
a second conduit surrounded by the protective layer; and
a second sensing optical fiber extending through the second conduit,
wherein the compartmentalized sensing elements separately respond to pressure incident on the conduit, and the second sensing optical fiber is configured to respond along its length to a parameter other than pressure.

8. The sensor as recited in claim 7, wherein the conduit has an elliptical transverse cross section, and wherein the second conduit has a circular transverse cross section.

9. A method of obtaining a distributed measurement of a parameter in a region of interest, comprising:
deploying a fiber optic distributed sensor in the region of interest, the fiber optic distributed sensor comprising:
a conduit;
a plurality of seals disposed in the conduit to form a series of adjacent sealed compartments; and
a sensing optical fiber extending through the sealed compartments to form a series of separate sensing elements configured to separately respond to a parameter that is incident on the conduit from the region of interest.

10. The method as recited in claim 9, further comprising coupling the fiber optic distributed sensor to a data acquisition system configured to obtain a response from each of the separate sensing elements corresponding to the parameter.

11. The method as recited in claim 10, wherein the fiber optic distributed sensor further comprises a protective layer to protect the conduit while in the region of interest, the protective layer configured to allow transmission of the parameter from the region of interest to the conduit.

12. The method as recited in claim 11, wherein the protective layer comprises a plurality of ports therethrough to allow the transmission of the parameter.

13. The method as recited in claim 10, wherein the fiber optic distributed sensor further comprises a parameter-transmitting medium disposed in each of the sealed compartments to enhance sensitivity of the sensing optical fiber to the parameter.

14. The method as recited in claim 13, wherein the conduit has an elliptical transverse cross section.

15. The method as recited in claim 14, wherein the parameter is pressure.

16. The method as recited in claim 15, wherein the fiber optic distributed sensor is deployed in a wellbore.

17. A method of obtaining a distributed measurement of a parameter of interest, comprising:
disposing a sensing optical fiber in a conduit, the sensing optical fiber configured to respond along its length to a parameter of interest;
disposing a transmission medium in the conduit to enhance transmission to the sensing optical fiber of the parameter of interest that is incident on the conduit;
sealing the conduit at a plurality of interior locations along the length of the conduit to provide a series of adjacent sealed compartments, each sealed compartment containing a portion of the transmission medium and a portion of the sensing optical fiber, thereby creating a compartmentalized conduit; and
disposing the compartmentalized conduit in a protective layer.

18. The method as recited in claim 17, further comprising providing a plurality of ports in the protective layer to transmit the parameter through the protective layer to the conduit.

19. The method as recited in claim 18, wherein the conduit has an elliptical transverse cross section.

20. The method as recited in claim 19, wherein the parameter of interest is pressure, and the method further comprises deploying the compartmentalized conduit in a wellbore to obtain a distributed measurement of pressure at a plurality of locations along the length of the compartmentalized conduit.

21. A fiber optic distributed measurement system, comprising:
a fiber optic sensor, comprising:
a conduit having a plurality of sealed compartments extending along the length of the conduit; and
a sensing optical fiber disposed in the conduit and extending through the sealed compartments to form a series of compartmentalized sensing elements that separately respond to a parameter incident along the conduit; and
a data acquisition subsystem configured to:
generate an optical signal to launch into the sensing optical fiber;
received from the sensing optical fiber backscattered light generated in response to the optical signal, wherein the backscattered light is affected by the parameter incident along the conduit; and
output data corresponding to the backscattered light to a processing subsystem to determine a characteristic of the parameter.

22. The system as recited in claim 21, wherein the fiber optic sensor further comprises a protective layer, wherein the conduit is surrounded by the protective layer, and wherein the protective layer is configured to allow transfer of the parameter through the protective layer to the conduit.

23. The system as recited in claim 22, wherein the protective layer comprises a plurality of ports therethrough to allow transfer of the parameter to the conduit.

24. The system as recited in claim 22, further comprising a transmission medium to enhance response of the sensing optical fiber to the parameter.
